(19) United States
(12) Patent Application Publication
(10) Pub. No.: US 2005/0235759 A1
(43) Pub. Date: Oct. 27, 2005

(54) DRUG-SPECIFIC FLUID DELIVERY SYSTEM

(75) Inventors: Douglas Ray Sparks, Whitmore Lake, MI (US); Nader Najafi, Ann Arbor, MI (US)

Correspondence Address: HARTMAN & HARTMAN, P.C., 552 EAST 700 NORTH, VALPARAISO, IN, 46383, US

(73) Assignee: INTEGRATED SENSING SYSTEMS, INC., Ypsilanti, MI (US)

(21) Appl. No.: 10/908,389

(22) Filed: May 10, 2005

Related U.S. Application Data
(63) Continuation-in-part of application No. 10/708,509, filed on Mar. 9, 2004.
(63) Continuation-in-part of application No. 10/248,839, filed on Feb. 24, 2003, now Pat. No. 6,932,114.
(60) Provisional application No. 60/569,278, filed on May 10, 2004.

(51) Int. Cl. G01F 1/708

(52) U.S. Cl. 73/861.352

(57) ABSTRACT

A fluid delivery system and method that combine a fluid source and an inline unit capable of delivering a precise amount of a therapeutic fluid to a patient based on specific data associated with the fluid, such as its identity, density, dosage, and dosage rate, so that the correct fluid is safely delivered in controlled amounts specific to its characteristics, purpose, and intended destination. The inline unit includes a flow controller and a flow sensor that produces a signal corresponding to the flow rate of the fluid flowing therethrough. The system further includes memory containing the data associated with the fluid, and electronic circuitry that causes the controller to regulate flow from the fluid source at the prescribed dosage rate and to deliver the prescribed dosage amount from the fluid source based on the signal from the sensor and the data contained by the memory.

### CROSS REFERENCE TO RELATED APPLICATIONS

This application is a continuation-in-part patent application of co-pending U.S. patent application Ser. No. 10/708,509 to Sparks et al., which is a continuation-in-part patent application of co-pending U.S. patent application Ser. No. 10/248,839 to Sparks. This application also claims the benefit of U.S. Provisional Application No. 60/569,278, filed May 10, 2004.

### BACKGROUND OF THE INVENTION

The present invention generally relates to a combination drug and fluid handling system packaged for accurately delivering controlled amounts of one or more specific drugs to a patient at accurately controlled rates.

Infusion therapy generally involves the administration of a fluid medication (liquid, spray, suspension, gas, etc.) to a subject using various delivery techniques, including intravenous (IV), transdermal, subcutaneous (SQ), intramuscular (IM), intra-arterial (IA), inhalation (INH), intarthecal, nasal, gastostomy tube, Dobhoff tube, jejunostomy tube, etc. Certain infusion therapies benefit from the ability to deliver a medication in controlled amounts and at controlled rates. While hand-actuated syringes are acceptable in many applications, they are often not sufficiently accurate for those infusion therapies requiring extremely small amounts of fluids to be delivered in a very precise manner. Furthermore, hand-actuated syringes are prone to many types of human errors, such as errors in dosage amount, dose rate, and medicine type. Consequently, a wide variety of fluid infusion pumps have been developed over the years that are capable of delivering medication at a controlled rate. Such pumps include elastomeric, gravity fed, syringe, electrical, and mechanical pumps. Valves and flow sensors have been incorporated into some infusion pump designs to improve dosage accuracy and to control the flow of fluids through these systems. More recently, micromachined flow sensors, valves and pumps have been developed, some of which have been used in medication delivery applications. Precise fluid control and measurement made possible with the above equipment and devises can also be useful in other medical applications, such as drug compounding and urological and blood analysis.

The accuracy of infusion pumps typically ranges from about +/−15% for volumetric pumps, down to about +/−3% for syringe pumps. While mass flow sensors that operate on the basis of the Coriolis effect can provide flow rate measuring accuracies of under +/−1%, their high cost and general requirements for relatively high flow rates have historically limited their use in the medical field. More recently, a Coriolis flow sensing device disclosed in commonly-assigned U.S. Pat. No. 6,477,901 to Tadigadapa et al. has been proven capable of sensing extremely low volumetric flow rates (e.g., less than 1 ml/hr), and therefore is well suited for drug delivery applications. The sensing device has a micromachined resonating tube that operates on the basis of the Coriolis effect to sense mass flow and density of a flowing fluid, and uses an electrostatic drive and capacitive sensing that require little power for operating the device.

All of the above-noted delivery devices, as well as other liquid drug delivery devices, are designed to be capable of delivering any of a variety of medications. Nonetheless, new delivery technologies are continuously sought, particularly for certain new medications and where new delivery techniques for existing medications offer the potential for results that are not obtainable with delivery techniques existing at the time the medications were first made available. For example, such treatments can be desirable in terms of improved dose control and metering accuracies, smaller concentrations that can be delivered, in some cases locally and resolution.

### BRIEF SUMMARY OF THE INVENTION

The present invention provides a fluid delivery system and method that combine a fluid source, a therapeutic fluid within the fluid source, and means capable of delivering a precise amount of the fluid to a patient based on specific data regarding the fluid, such as the identity, density, dosage, and dosage rate of the fluid, so that the correct fluid is safely delivered in controlled amounts specific to its characteristics, purpose, and intended destination.

The fluid delivery system generally includes at least one fluid source containing a fluid having a therapeutic effect when delivered in a prescribed dosage amount and at a prescribed dosage rate to a patient. Fluidically coupled in series to the fluid source are a flow controlling means and a flow sensing means, the latter of which produces a signal corresponding to the flow rate of the fluid flowing therethrough. The fluid delivery system further includes memory means containing data corresponding to the fluid and its prescribed dosage amount and dosage rate, electronic means in communication with the flow controlling means, the flow sensing means, and the memory means, and means for infusing the fluid in the patient. The electronic means is operable to cause the flow controlling means to regulate flow of the fluid from the fluid source at the prescribed dosage rate and to deliver the prescribed dosage amount from the fluid source based on the signal from the flow sensing means and the data contained by the memory means.

The fluid delivery method involves providing a fluid delivery system comprising at least one fluid source containing a fluid having a therapeutic effect when delivered in a prescribed dosage amount and at a prescribed dosage rate to a patient, flow controlling means and a flow sensing means fluidically coupled in series with the fluid source, memory means containing data corresponding to the fluid and its prescribed dosage amount and dosage rate, and electronic means in communication with the flow controlling means, the flow sensing means, and the memory means. The electronic means is operated to cause the flow controlling means to initiate flow of the fluid from the fluid source, through the flow controlling means and the flow sensing means, and into the patient. The flow sensing means is operated to produce a signal corresponding to the flow rate of the fluid flowing therethrough. The electronic means is further operated to cause the flow controlling means to regulate flow of the fluid from the fluid source at the prescribed dosage rate based on the signal from the flow sensing means and the data contained by the memory means. The electronic means is also operated to cause the flow controlling means to stop flow of the fluid from the fluid source after the prescribed dosage amount has been delivered to the patient based on the signal from the flow sensing means and the data contained by the memory means.

The fluid delivery system and method can be adapted for a variety of applications, especially those within the medical industry. For example, the system and method can be used to deliver one or more fluids using a variety of drug infusion techniques, including but not limited to intravenous (IV), transdermal, subcutaneous (SQ), intramuscular (IM), intra-arterial (IA), inhalation (INH), intarthecal, nasal, gastostomy tube, Dobhoff tube, jejunostomy tube, etc., and for the treatment of a wide variety of conditions and diseases, including but not limited to diabetes, HIV, AIDS, cancers including leukemia, lymphoma, breast cancer, melanoma, and testicular cancer, malaria, congestive heart failure, tuberculosis, hepatitis, bacterial infections, viral infections, postoperative infections, chronic pain, age-related illnesses, nicotine addiction, narcotic addiction, and alcoholism. A feature of the invention is that the system can be manufactured and sold as a unitary device comprising the fluid source, the fluid, the flow controlling means, the flow sensing means, the memory means, and the electronic means, with any one or more of its components being disposable or reusable. As a unitary device, the fluid delivery system can be produced and delivered directly to a medical care provider, with the data corresponding to the fluid and the prescribed dosage amount and rate thereof already stored in the memory means. Alternatively, the fluid delivery system can be produced so that a medical care provider can input the prescribed dosage amount and dosage rate of the fluid. Still another feature of the invention is that the fluid delivery system can be secured to the patient, such that the patient can be treated while outside the immediate control of the medical care giver.

Other objects and advantages of this invention will be better appreciated from the following detailed description.

### BRIEF DESCRIPTION OF THE DRAWINGS

FIG. 1 is a schematic representation of a fluid delivery system in accordance with an embodiment of this invention.

FIGS. 2 and 3 depict fluid delivery systems in accordance with particular embodiments of the invention.

### DETAILED DESCRIPTION OF THE INVENTION

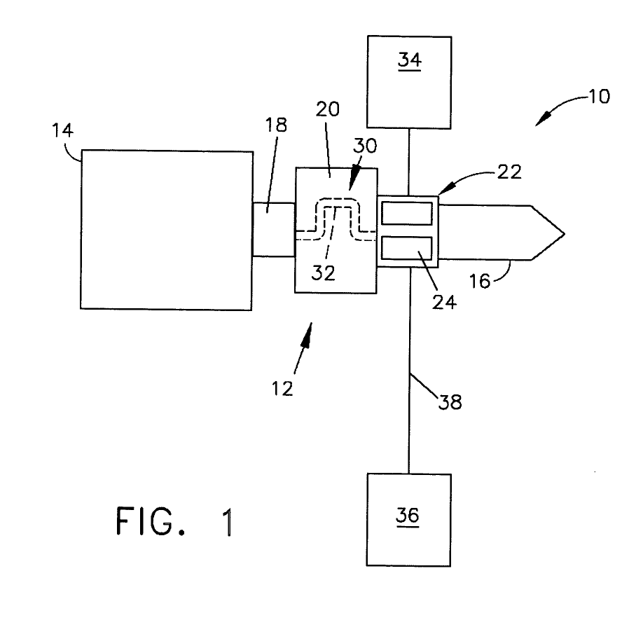

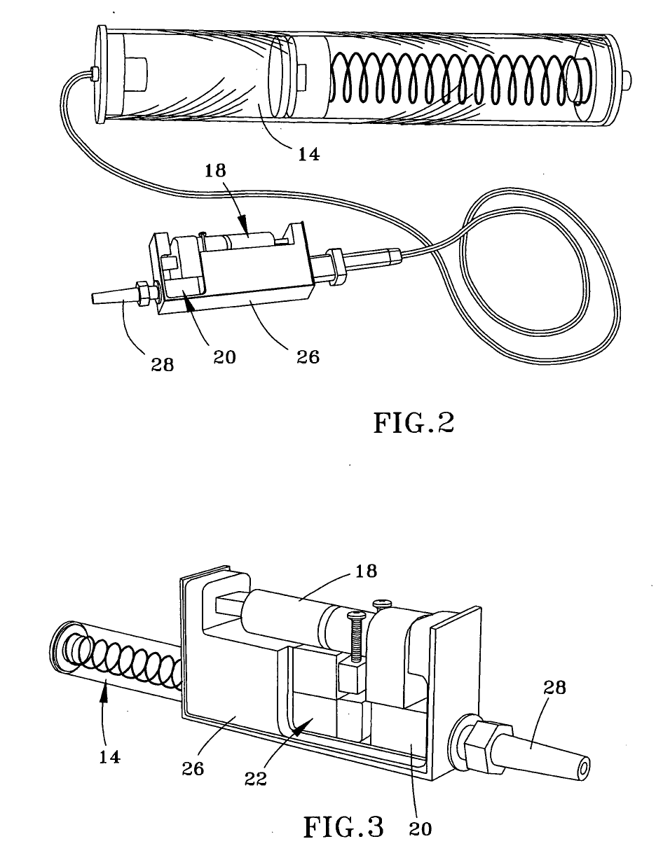

With reference to FIG. 1, a fluid delivery system 10 is schematically represented as including an inline unit 12 through which a fluid flows for delivery from a fluid source 14 to a patient via an infusion device 16. The unit 12 is termed “inline” because it is physically mounted between the fluid source 14 and the infusion device 16 that delivers the fluid to its intended destination. As will become evident from the following, a variety of fluid sources 14 are suitable for use with the system 10, such as a reservoir 14 pressurized with an elastic membrane as shown in FIG. 2, a spring-loaded cartridge 14 as shown in FIG. 3, a reservoir from which the fluid is delivered by a pump or solely under the force of gravity, or another type of liquid containing system. When empty, the fluid source 14 can be replaced or refilled, or the entire system 10 disposed of, as will also become evident from the following discussion. The fluid source 14 can also comprise multiple drug reservoirs, each containing a different medication that can be simultaneously or sequently delivered through the inline unit 12. The infusion device 16 may take a variety of forms, including but not limited to needles, patches, cannulas, tubes, and nozzles. As such, the fluid delivery system 10 can be used to administer medications by a variety of methods, e.g., intravenous (IV), transdermal, subcutaneous (SQ), intramuscular (IM), intra-arterial (IA), inhalation (INH), intarthecal, nasal, gastostomy tube, Dobhoff tube, jejunostomy tube, etc.

According to a preferred aspect of this invention, the inline unit 12 comprises a flow control device 18, a flow sensing device 20, and electronic circuitry 22. The flow control device 18 and flow sensing device 20 are fluidically coupled in series with the fluid source 14. While the control device 18 is shown as being located between the fluid source 14 and sensing device 20, it is foreseeable that the sensing device 20 could be located upstream of the control device 18. The flow control device 18, flow sensing device 20, and circuitry 22 may be enclosed within a single housing (as shown in FIGS. 2 and 3) or within two or more separate housings to provide a modular design. Power for the flow control device 18, flow sensing device 20, and circuitry 22 can be provided by a battery (not shown) physically connected to the inline unit 12 or can be delivered telemetrically using known tele-powering techniques.

The flow sensing device 20 is represented as comprising a tube 30 that serves as a conduit through which the fluid flows as it flows through the inline unit 12. The tube 30 has a freestanding portion 32 adapted to be vibrated at resonance in a manner that enables certain properties of the fluid to be measured using Coriolis force principles. A preferred Coriolis-type resonating tube flow sensor is taught in U.S. Pat. No. 6,477,901 to Tadigadapa et al., incorporated herein by reference. In Tadigadapa et al., wafer bonding and silicon etching techniques are used to produce a wafer with a suspended silicon tube, corresponding to the freestanding tube portion 32 of the flow sensing device 20. The freestanding tube portion 32 is vibrated at resonance such that, as fluid flows through the tube 30, the freestanding tube portion 32 twists under the influence of the Coriolis effect. As explained in Tadigadapa et al., the degree to which the freestanding tube portion 32 twists (deflects) when vibrated can be correlated to the mass flow rate of the fluid flowing through the tube 30 on the basis of the change in the amplitude of a secondary resonant vibration mode. The density of the fluid is proportional to the natural frequency of the fluid-filled vibrating tube portion 32, such that controlling the vibration of the tube portion 32 to maintain a frequency at or near its resonant frequency will result in the vibration frequency changing if the density of the fluid flowing through the tube 30 changes. As depicted in FIG. 1, the freestanding tube portion 32 is preferably U-shaped, though other shapes—both simpler and more complex—are within the scope of this invention.

The resonating tube flow sensor of Tadigadapa et al. is preferred for use as the sensing device 20 of this invention, though it is foreseeable that other types of flow sensors could be employed. For example, hot wire, thin-film, and drag force flow sensors of types known in the art could be employed in this system. However, a disadvantage of hot wire or hot film devices is that they can damage delicate biological molecules used in some medical treatments. Another disadvantage is that they require high electrical current levels to generate heat, a portion of which is lost to the fluid being sensed. Particularly advantageous aspects of the resonating tube sensor of Tadigadapa et al. include its very small size and its ability to precisely measure extremely small amounts of fluids, in contrast to prior art Coriolis-type flow sensors. Furthermore, the flow sensor of Tadigadapa et al. can attain flow rate measurement accuracies of under +/−0.1%, in contrast to other types of infusion pumps whose accuracies can range from about +/−15% for volumetric pumps and +/−3% for syringe pumps. While the high cost and the high flow rate requirements for prior art Coriolis-type flow sensors have restricted their use in the drug delivery arena, the flow sensor of Tadigadapa et al. is able to sense the extremely low flow rates (e.g., less than 1 ml/hr) required by infusion therapy applications. Another advantage is that the preferred flow sensor uses an electrostatic drive and capacitive sensing (not shown in FIG. 1), which minimizes the power requirements of the sensor. Accordingly, the flow sensor taught by Tadigadapa et al. is ideal for achieving the high accuracy, small size, and low power requirements needed for drug infusion systems.

The flow control device 18 can be an actuator of a known type, such as a solenoid valve, stepper motor, pump, etc. The flow control device 18 can be a separate component or integrated onto the same micromachined chip as the flow sensing device 20 to shrink the size and power requirements of the inline unit 12. A pressure sensor (not shown) can also be integrated onto the same chip or provided as a separate unit to sense occlusions within the system 10.

The system 10 of FIG. 1 enables an otherwise conventional fluid source 14 and flow control device 18 to controllably deliver a precise amount of fluid to a patient. The mass flow rate and density of the fluid discharged from the fluid source 14 is detected by the flow sensing device 20. Mass flow rate, density, and/or the volumetric flow rate is computed therefrom by the electronic circuitry 22, which preferably includes a timing device so that the volumetric flow rate can be used to calculate the actual amount of fluid dispensed through the flow sensing device 20, thereby giving a very accurate indication of the amount of fluid delivered through the infusion device 16. Notably, with the preferred Coriolis-based flow sensing device 20 and an appropriate flow control device 18, the same precision can be achieved regardless of the type of fluid source 14 used, including various manually-operated and machine-operated pumps such as the pressurized reservoir 14 and spring-loaded cartridge 14 of FIGS. 2 and 3, as well as relatively low cost pumps whose lower accuracy would otherwise exclude their use in the medical applications contemplated by the present invention.

In the embodiments represented in FIGS. 2 and 3, the inline units 12 and circuitry 22 are shown as being held in similarly configured housings 26, though it is foreseeable that the system 10, the housings 26, and the individual components of the system 10 could have a variety of other configurations. The housings 26 are each shown as being equipped with an outlet fitting 28 adapted for connecting to a suitable infusion device (16 in FIG. 1). The housings 26 may also include optional features such as a display panel and/or lights for indicating information regarding the operation of the system 10, a horn or other device for producing an audible or visual signal or alarm, and a battery or tele-powering device for powering the system 10. Electrical interconnections are preferably made within the housings 26 so that electrical power is delivered to their flow control devices 18, flow sensing devices 20, and circuitry 22, outputs from the flow sensing devices 120 (e.g., density and mass flow rate) are delivered and processed by the circuitry 22, and control signals from the circuitry 22 are delivered to the flow control device 18.

According to a preferred aspect of the invention, the operation of the system 10 is preferably based on the specific type of medication contained in the fluid source 14 and to be administered to a patient. For this purpose, one or more suitable memory devices 24 are preferably integrated with the electronic circuitry 22 and store data specific to the particular medication, such as its identity, density, dosage amounts, dosage rates, etc. Depending on the manner in which the system 10 is intended for use, certain data (such as the identity and density/specific gravity of the medication) can be stored in permanent memory, while other data (such as the desired dosage and dosage rate for the medication) can be stored in programmable memory to permit a medical care giver to select a treatment appropriate for an individual patient. For this purpose, FIG. 1 shows the system 10 as also including a remote device 34 that is wired or wirelessly communicates with the circuitry 22. For example, the device 34 may be a desktop computer or a handheld unit for remote programming of the circuitry 22 and its memory 24. Alternatively or in addition, the device 24 can serve to monitor and display information regarding the operation of the system 10. As discussed above, the preferred flow sensing device 20 produces density and flow rate outputs from which the electronic circuitry 22 (and/or an optional remote computer or unit 24) can calculate volumetric flow rate and dosage, either or both of which can be used to control the flow control device 18, e.g., open, close, or adjust to regulate fluid flow through the flow control device 18.

The safety of an infusion process performed with the fluid delivery system 10 described above is promoted by the ability to program the circuitry 22 (or, optionally, a remote computer or unit 24) for a specific drug (having a known specific gravity or density range) with a prescribed dose and dose rate. Should any one or more of these programmed values be exceeded, as sensed by the flow sensing device 20, the circuitry 22 (and/or remote device 24) can cause a visual and/or audible warning to be generated with a display panel, horn, etc., and operate the flow control device 18 to stop drug infusion. As such, customizing the system 10 for a specific drug provides another layer of patient protection to prevent medication, dose, and dose rate errors, all of which cause unwanted death and injury to thousands of patients each year. Two-way communication between the system 10 and the remote device 24 during infusion can be further utilized to alert other caregivers that an error in medicine, dose, or dose rate has occurred. In view of its small size, the system 10 can be secured to a patient and the fluid administered while the patient is outside the immediate control of the medical care giver, such as while the patient is going about his or her daily routine.

The fluid delivery system 10 of this invention is suitable for treating a variety of conditions, including but not limited to diabetes, HIV, AIDS, cancers including but not limited to leukemia, lymphoma, breast cancer, melanoma, and testicular cancer, malaria, congestive heart failure, tuberculosis, hepatitis, bacterial infections, viral infections, postoperative infections, chronic pain, age-related illnesses, nicotine addiction, narcotic addiction, and alcoholism. As such, a wide variety of medications can be administered with the system, including but not limited to: insulin (for the treatment of diabetes); AZT, 3TC, D4T, ddc, ddi, Ziagen, Viramune, T-20, T-1249, Invirase, Novir, Crixivan, Viracept, Agenerase, Kaletra, and Combivir in combination with antinausea drugs, pain relievers, antivirals, and antibiotics to fight infections caused by immune system suppression (for the treatment of HIV/AIDS); alemtuzuab, allopurinol, arsenic trioxide, asparaginase, cytarabine, daunorubicin, fludarabine, idarubicin, mitoxantrone in combination with antinausea drugs, pain relievers, and antibiotics to fight infections caused by immune system suppression (for the treatment of leukemia); carmustine, chlorambucil, denileukin diftitox, ibritumomab tiuxetan, lomustine, tositumomab in combination with antinausea drugs, pain relievers, and antibiotics to fight infections caused by immune system suppression (for the treatment of lymphoma); docetaxel, fulvestrant, pamidronate, thotepa, trastuzumab, in combination with antinausea drugs, pain relievers, and antibiotics to fight infections caused by immune system suppression (for the treatment of breast cancer); dacarbazine and interferon in combination with antinausea drugs, pain relievers, and antibiotics to fight infections caused by immune system suppression (for the treatment of melanoma); cisplatin, etoposide phosphate, ifosfamide, vinblastine, in combination with antinausea drugs, pain relievers, and antibiotics to fight infections caused by immune system suppression (for the treatment of testicular cancer); primquine, proguanil, doxcycline, azithromycin, fosidomycin, methylene blue, desbutylhalofamtrine, artemisone, mefloquine (for the prevention and treatment of malaria), anticoagulants, angina treatments, diuretics, antiarrhythmics, digitalis glycosides, digoxin, digitoxin, lidocaine, phenyloin, quinidine, procainamide, cholestyramine, colestipol, thiazides, triamterene, amiloride, spironolactone, aldosterone, nitroglycerin (for the treatment of congestive heart failure (CHF)); antibiotics, isoniazid, rifampicin, pyrazinamide, streptomycin (for the treatment of tuberculosis); and various antibiotics (for the prevention and treatment of postoperative infections).

There are a number of drug treatments in which tight flow rate control or dose is particularly critical. Drugs having a narrow therapeutic index (NTI) or range have been defined by the FDA on the basis of the ratio of the median effective dose value of a drug and its median lethal dose or minimum toxic concentration, and whether safe and effective use of the drug requires careful titration and patient monitoring. Such drugs must be administered carefully, as errors in the dose or delivery rate can injure or kill a patient. Additional drugs fall into this category if the patient is an infant or child. Because the system 10 of this invention improves the ability to carefully deliver and monitor the dose of drugs, NTI drugs that are candidates for delivery with this invention include a variety of compounds including, but not restricted to, the following drugs and combinations thereof: 5-fluorouracil, acenocumarol, amikacin, aminoglycocides, amniophylline, amphotericin B, anthydisrhythnics, anti-cancer medicines, anticoagulants, anticonvulsants, antifungals, antiretrovirals, carbamazepine, clindamycin, clonidine, coumadin, cyclosporine, depakene, depakote, digitalis glycosides, Digoxin®, Dilantin®, disopyramide, divalproex sodium, dyphilline, eskalith, Gentamicin®, glibenclamide, guanethidine, immunosuppressives, Isoetharine mesylate, isoproterenol, lanoxin, levoxyine, Lidocaine®, lithium, lithium carbonate, Lithobid®, metaporterenol, minoxidil, neural, Norpace®, oxytriphylline, phenobarbital, Phenyloin®, Prazosin®, Primidone®, procainamide, procainbid, pronestyl-sr, quinidine, quinidine gluconate, Quinidix®, quinaglute, Slo-bid®, tacrolimus, Tegretol®, Theo-dur®, theophylline, tobramycin, valproic acid, valproate sodium, vancomycin, Warfarin®, warfarin sodium, and Zidovudine®.

In addition to NTI drugs, other drugs to which patients may have an allergic reaction are excellent candidates for use with the fluid delivery system 10 of this invention. For this purpose, the system 10 can be programmed to gradually administer the drug with very small, gradually increasing doses to begin the desensitization process, permitting the administration of antihistamines if a reaction occurs with the drug. As previously noted, the system 10 can be configured to simultaneously or sequentially administer multiple drugs, including antibiotics and drugs used to treat diseases such as cystic fibrosis, listeria endocarditis, and HIV-related PCP.

As shown in FIG. 1, a remote sensor 36 can be coupled for communication with the circuitry 22 by wire or wirelessly 38, such as with an IR, RF, optical, magnetic, or other wireless communication device known in the art. While a preprogrammed dose approach is a preferred aspect of the invention, the sensor 36 can be used to provide additional control of the timing, rate, and amount of medicine(s) dispensed with the system 10. For example, the sensor 36 can be a glucose sensor to monitor the glucose level of the patient's blood. When the level goes above or below preset limits, the sensor 36 can notify the circuitry 22, which in turn signals the flow control device 18 to commence the delivery of insulin to the patient. It is foreseeable that a variety of remote sensors 36 could be advantageously employed by the fluid delivery system of this invention.

While the invention has been described in terms of certain embodiments, it is apparent that other forms could be adopted by one skilled in the art. Therefore, the scope of the invention is to be limited only by the following claims.

1. A fluid delivery system comprising:
at least one fluid source containing a fluid having a therapeutic effect when delivered in a prescribed dosage amount and at a prescribed dosage rate to a patient;
means fluidically coupled with the fluid source for controlling flow of the fluid from the fluid source;
flow sensing means fluidically coupled in series with the fluid source and the flow controlling means, the flow sensing means producing a signal corresponding to the flow rate of the fluid flowing therethrough;
memory means containing data corresponding to the fluid and the prescribed dosage amount and dosage rate thereof;
electronic means in communication with the flow controlling means, the flow sensing means, and the memory means, the electronic means being operable to cause the flow controlling means to regulate flow of the fluid from the fluid source at the prescribed dosage rate and to deliver the prescribed dosage amount from the fluid source based on the signal from the flow sensing means and the data contained by the memory means; and
means for infusing in the patient the fluid caused to flow through the flow controlling means and the flow sensing means by the electronic means.

2. The fluid delivery system according to claim 1, wherein the flow sensing means comprises a sensing element having a first output corresponding to the density of the fluid flowing therethrough and a second output corresponding to the mass flow rate of the fluid flowing therethrough.

3. The fluid delivery system according to claim 1, wherein the flow sensing means comprises:
a freestanding tube portion through which the fluid flows;
means for vibrating the freestanding tube portion at a resonant frequency thereof that varies with the density of the fluid flowing therethrough, the Coriolis effect causing the freestanding tube portion to twist to a degree that varies with the flow rate of the fluid flowing therethrough while the freestanding tube portion is vibrated at resonance; and
means for sensing movement of the freestanding tube portion to sense the resonant frequency and the degree of twist of the freestanding tube portion as the fluid flows therethrough, the signal from the flow sensing means being obtained from a first output corresponding to the resonant frequency of the freestanding tube portion and a second output corresponding to the degree of twist of the freestanding tube portion.

4. The fluid delivery system according to claim 1, wherein the system is a unitary device comprising the fluid source, the fluid, the flow controlling means, the flow sensing means, the memory means, and the electronic means.

5. The fluid delivery system according to claim 1, wherein the electronic means is operable to cause the flow controlling means to stop flow of the fluid from the fluid source based on the data contained by the memory means.

6. The fluid delivery system according to claim 1, wherein the flow sensing means is operable to sense the density of the fluid flowing therethrough, and the electronic means is operable to cause the flow controlling means to stop flow of the fluid from the fluid source by comparing the density of the fluid to the data contained by the memory means.

7. The fluid delivery system according to claim 1, wherein the electronic means is operable to cause the flow controlling means to stop flow of the fluid from the fluid source if the prescribed dosage rate is not met based on the data contained by the memory means and the signal from the flow sensing means.

8. The fluid delivery system according to claim 1, further comprising means for sensing a physiological parameter of the patient and means for communicating a control signal to the electronic means based on the physiological parameter, wherein the electronic means is operable to cause the flow controlling means to initiate and stop flow of the fluid from the fluid source based on the physiological parameter.

9. The fluid delivery system according to claim 1, wherein the data corresponding to the fluid are permanently stored in the memory means.

10. The fluid delivery system according to claim 1, further comprising means for inputting into the memory means the data corresponding to the prescribed dosage amount and dosage rate of the fluid.

11. A fluid delivery method comprising:
providing a fluid delivery system comprising at least one fluid source containing a fluid having a therapeutic effect when delivered in a prescribed dosage amount and at a prescribed dosage rate to a patient, flow controlling means and flow sensing means fluidically coupled in series with the fluid source, memory means containing data corresponding to the fluid and the prescribed dosage amount and dosage rate thereof, and electronic means in communication with the flow controlling means, the flow sensing means, and the memory means;
operating the electronic means to cause the flow controlling means to initiate flow of the fluid from the fluid source, through the flow controlling means and the flow sensing means, and into the patient;
operating the flow sensing means to produce a signal corresponding to the flow rate of the fluid flowing therethrough;
operating the electronic means to cause the flow controlling means to regulate flow of the fluid from the fluid source at the prescribed dosage rate based on the signal from the flow sensing means and the data contained by the memory means; and
operating the electronic means to cause the flow controlling means to stop flow of the fluid from the fluid source after the prescribed dosage amount has been delivered to the patient based on the signal from the flow sensing means and the data contained by the memory means.

12. The fluid delivery method according to claim 11, wherein the flow sensing means comprises a sensing element that produces a first output corresponding to the density of the fluid flowing therethrough and a second output corresponding to the mass flow rate of the fluid flowing therethrough.

13. The fluid delivery method according to claim 11, wherein the step of operating the flow sensing means comprises:
flowing the fluid through a freestanding tube portion;
vibrating the freestanding tube portion of at a resonant frequency thereof; and
sensing movement of the freestanding tube portion to sense a resonant frequency and a degree of twist of the freestanding tube portion as the fluid flows therethrough, the resonant frequency corresponding to the density of the fluid flowing through the freestanding tube and the degree of twist corresponding to the flow rate of the fluid flowing through the freestanding tube, the signal from the flow sensing means being obtained from a first output corresponding to the resonant frequency of the freestanding tube portion and a second output corresponding to the degree of twist of the freestanding tube portion.

14. The fluid delivery method according to claim 11, further comprising the steps of:
operating the flow sensing means to sense the density of the fluid flowing therethrough; and
operating the electronic means to cause the flow controlling means to stop flow of the fluid from the fluid source by comparing the density of the fluid to the data contained by the memory means.

15. The fluid delivery method according to claim 11, further comprising the step of sensing a physiological parameter of the patient, communicating a control signal to the electronic means based on the physiological parameter, and operating the electronic means to cause the flow controlling means to initiate and stop flow of the fluid from the fluid source based on the physiological parameter.

16. The fluid delivery method according to claim 11, wherein the fluid delivery system is produced and delivered as a unit to a medical care provider.

17. The fluid delivery method according to claim 16, wherein the fluid delivery system is delivered to the medical care provider with the data corresponding to the fluid already stored in the memory means.

18. The fluid delivery method according to claim 16, wherein the fluid delivery system is delivered to the medical care provider with the data corresponding to the prescribed dosage amount and dosage rate of the fluid already stored in the memory means.

19. The fluid delivery method according to claim 16, wherein the data corresponding to the prescribed dosage amount and dosage rate of the fluid are stored in the memory means by the medical care provider.

20. The fluid delivery method according to claim 11, wherein the method is performed to treat at least one disease chosen from the group consisting of diabetes, HIV, AIDS, leukemia, lymphoma, cancer, malaria, congestive heart failure, tuberculosis, hepatitis, bacterial infections, viral infections, postoperative infections, chronic pain, age-related illnesses, nicotine addiction, narcotic addiction, and alcoholism.

21. The fluid delivery method according to claim 11, further comprising the step of securing the fluid delivery system to the patient, and wherein the operating steps are performed while the patient is outside the immediate control of the medical care giver.
